(19) United States
(12) Patent Application Publication
(10) Pub. No.: US 2013/0155009 A1
(43) Pub. Date: Jun. 20, 2013

(54) COLLABORATION TOUCH SCREEN WORKTABLE

(71) Applicant: Logiciels Smart-Use Inc., Montreal (CA)

(72) Inventor: Dominic SEVIGNY, Saint-Basile-Le-Grand (CA)

(73) Assignee: LOGICIELS SMART-USE INC., Montreal (CA)

(21) Appl. No.: 13/674,182

(22) Filed: Nov. 12, 2012

Related U.S. Application Data
(60) Provisional application No. 61/564,068, filed on Nov. 28, 2011.

(51) Int. Cl. G06F 3/044

(52) U.S. Cl. CPC G06F 3/044
USPC 345/174

(57) ABSTRACT

An electronic collaboration table for interacting with plans is provided. The electronic collaboration table includes a touch screen interface at an angle, preferably 40°. The touch screen interface is configured to display and interact with plans, including plan selection, plan pair selection, plan pair registration, plan pair comparison, plan differences display, annotation and measurement (materials estimation

### TECHNICAL FIELD

This invention relates to mechanical drafting, for example to an apparatus providing a human-machine interface for interactivity with design drafting plans, and in particular to a draftsman's computerized drafting table having a touch screen interface for enabling collaboration.

### BACKGROUND

In a variety of fields, draftsmen (men and women alike) employ Computer Aided Design (CAD) software to draw out, in a virtual space, the past, current and desired end states of their projects. For example, for architectural works, project milestones include the bare land, the dig-out phase, the foundation, the building, the final landscaped property, etc. In semiconductor electronics, each deposition and/or etch layer can represent a project state. In mechanical engineering, production and assembly of each component can represent a state. The draw-out nowadays is performed on a computer screen where the draftsman can zoom in and out to the extent required.

For each such, and other (proposed or interim), states, draftsmen provide a number of views in the form of a design drafting plan, herein after a plan. Due to the typical enormous amount of information included in such plans, even in today's computerized world, these plans are printed out in large sheets typically larger than 40 in by 40 in and bound together in a folio. Considering an architectural example, say a building, the following minimum set of plans would be present: the land division plan, services plan, road plan, land elevation plan, dig-out plan, foundation plan, and for each floor in the building a floor plan, a plumbing plan, a electrical plan, etc. It is understood that basement and ground floors can be unique and that upper floor can be similar, as well mechanical floors when present can be different. Engineers and tradesmen need to interact with a large number of plans to accomplish the end result.

Besides such large number of initial plans, modifications in the course of build-out are the norm, and modified plans are prepared, printed out kept bound separately or together with the originals for reference as needed.

Engineering architectural paper plan management, and interaction therewith, is very time consuming and extremely inconvenient. Electronic plan management exists but always culminates in a plan stack print-out because unfortunately the computer screens employed in draw-out do not provide convenient interaction for collaboration. At the other extreme, the current mode of collaboration “with pen and paper plan” so-to-speak lacks easy off-site communication as paper plans have to be scanned before being transmitted electronically.

There is a need to improve human machine interaction in this space.

### SUMMARY

It has been discovered that draftsmen, architects, and engineers alike prefer the use of a drafting table for both design and collaboration. In accordance with an aspect of the proposed solution there is provided an electronic collaboration table which includes a tactile human-machine interface.

It has been discovered that interacting with a horizontal surface tends to limit collaboration as only a limited number of individuals can gather around (a limited number of individuals can look on over the shoulder), while interacting with a vertical surface tends to be tiring on the arms while limiting collaborator gathering to a single side (i.e. in front). In accordance with an aspect of the proposed solution there is provided an electronic collaboration table including a tactile human-machine interface at an ergonomic angle of about 40°.

A large number of Computer Aided Design (CAD) software applications exist each purposefully designed for the different disciplines required to complete projects large and/or small. It has been discovered that electronic collaboration benefits from a unified electronic plan source, for example provided by plans output in Portable Document Format (PDF) and particularly output in the vector graphics specification variety of PDF. Without limiting the invention, the raster bitmap specification variety of PDF can also work. For certainty, the invention is not limited to employing PDF plan source, and references to PDF vector graphics specification is used only for brevity of description herein. Other electronic plan specifications exist and can be used as well including AutoCAD™ .dxf and .dwg files. (“AutoCAD” is a trademark of Autodesk Inc.)

It has been discovered that electronic collaboration greatly benefits from zoom-in and zoom-out functionality. In accordance with a further aspect of the proposed solution a viewable bounding box specific zooming is provided.

Collaboration entails both information in plan drawings/views, as well information about such plans/drawing/views. For example, plan views of a semiconductor layer can include a number of revisions as well customer design specification plans/views and verification plans/views. In electronic form, information about such plans in maintained in plan metadata, file names, file naming conventions, version control file management databases, etc. It has been discovered that information about applicable plans can further enhance ease of electronic collaboration. For example, information specifying applicable plans represents semantic metadata including rules specifying that an architectural set of plans requires plumbing/drainage plans whereas a semiconductor chip layout set of plans would not. In accordance with a further aspect of the proposed solution, both vector graphics plan specifications, plan metadata, file names, file naming conventions, semantic metadata, version control information, etc. is converted to an eXtendable Markup Language (XML) format providing a unification of plan related information management and processing.

Collaboration almost always entails working with multiple versions of a plan, related plans and, if not, results in the creation of a plan modification/suggestion. It is recognized that currently paper plan comparison requires printing on tracing paper and/or scanning, both of which are time consuming and inconvenient. In accordance with a further aspect of the proposed solution virtual transparent plan superposition and comparison is provided.

Results of collaboration typically result is desired plan changes/suggestions. In accordance with an embodiment of the proposed solution, touch screen interactivity functionality is provided for annotating plans, for plan annotation storage, for annotation association with a user, for plan annotation association with at least one plan.

Reference to plans can also be made for purposes of materials estimation. In accordance with another aspect of the proposed solution, a virtual ruler is provided to aid in materials estimation and other related project planning endeavors.

In accordance with an aspect of the proposed solution there is provided an electronic collaboration table for interaction with design drafting plans, the apparatus comprising: a high definition television (HDTV) flat panel screen display having a diagonal image measurement of between 45 to 65 inches; a wheeled base frame for supporting the flat screen display at a fixed acute angle in a landscape orientation at a height suitable for working at said display while seated or standing, said support frame and said angle allowing said display mounted on said support frame to be wheeled through a 32″ doorframe; and a multi-touch recognition system mounted to said table for recognizing operator finger touches on said flat screen display.

In accordance with another aspect of the proposed solution there is provided an electronic collaboration table for interaction with design drafting plans, the apparatus comprising: a human-machine interface oriented at an acute angle from horizontal the touch screen interface including: a flat screen display; and a touch detection system positioned over the flat screen display; a collaboration computer configured to execute logic instructions for manipulating at least one plan during a collaboration session, and for processing tactile input received from said touch detection system; and electronic memory storage configured to retrievably store said logic instructions, an eXtensible Markup Language (XML) specification of at least one plan, and XML metadata regarding said at least one plan, said collaboration computer being further configured to provide an output at least on said flat screen display during said collaboration session based at least one of said XML vector graphics specification and XML metadata.

### BRIEF DESCRIPTION OF THE DRAWINGS

The invention will be better understood by way of the following detailed description of embodiments of the invention with reference to the appended drawings, in which:

FIG. 1 is a schematic diagram illustrating a front elevational view of an electronic collaboration table in accordance with an implementation of the proposed solution;

FIG. 2A is a schematic diagram illustrating a rear elevational view of the electronic collaboration table in accordance with the implementation of the proposed solution:

FIG. 2B is a schematic diagram illustrating a rear view of a detail of the electronic collaboration table in accordance with the implementation of the proposed solution;

FIG. 2C is a schematic diagram illustrating a rear view of another detail of the electronic collaboration table in accordance with the implementation of the proposed solution;

FIG. 3A is a schematic diagram illustrating a right-side elevational view of a side support member of the electronic collaboration table in accordance with the implementation of the proposed solution;

FIG. 3B is a schematic diagram illustrating a right-side elevational view of the electronic collaboration table in accordance with the implementation of the proposed solution;

FIG. 4 is schematic diagram illustrating sheet metal manufactured end caps for an electronic components space illustrated in FIGS. 2 and 3B as an example implementation of the proposed solution;

FIG. 5 is a schematic diagram illustrating a perspective view of a support framework in accordance with an embodiment of the proposed solution;

FIG. 6 is a schematic diagram illustrating a front view of the support framework in accordance with the embodiment of the proposed solution;

FIG. 7 is a schematic diagram illustrating a cross-sectional view of the support framework illustrated in FIG. 6 in accordance with the embodiment of the proposed solution;

FIG. 8 is a schematic diagram illustrating a rear view of the support framework in accordance with the embodiment of the proposed solution;

FIG. 9 is a schematic diagram illustrating a front view of the support framework and bezel in accordance with an implementation of the proposed solution;

FIG. 10 is a schematic diagram illustrating a cross-sectional view of the support framework illustrated in FIG. 9 in accordance with the embodiment of the proposed solution;

FIG. 11 is a schematic diagram illustrating an elevational view of an electronic collaboration table in accordance with another configuration of another embodiment of the proposed solution for transport;

FIG. 12 is a schematic pictorial view of a touch screen interface illustrating a virtual keyboard, menus and a hierarchical view of metadata in accordance with an implementation of the proposed solution;

FIG. 13 is a schematic pictorial view of a touch screen interface illustrating a virtual keyboard, context sensitive menus and a collapsed hierarchical view of metadata in accordance with an implementation of the proposed solution;

FIG. 14 is a schematic pictorial view of a touch screen interface illustrating page flip browsing of a folio in accordance with an implementation of the proposed solution:

FIG. 15 is a schematic pictorial view of a touch screen interface illustrating drag-down gesture selection of a plan from a folio in accordance with an implementation of the proposed solution;

FIG. 16 is a schematic pictorial view of a touch screen interface illustrating a selected plan pair and a context sensitive menu in accordance with an implementation of the proposed solution;

FIG. 17 is a schematic pictorial view of a touch screen interface illustrating transparent superposition of a pair of plans in accordance with an implementation of the proposed solution;

FIG. 18 is a schematic pictorial view of the touch screen interface illustrating a detail of a base plan in the pair of plans illustrated in FIG. 16 being compared in accordance with the implementation of the proposed solution;

FIG. 19 is a schematic pictorial view of the touch screen interface illustrating a detail of the base plan in solid black superimposed over the other comparison plan in gray with differences highlighted in the comparison plan in gray in accordance with the implementation of the proposed solution;

FIG. 20 is a schematic pictorial view of the touch screen interface illustrating a detail of the comparison plan in solid black with differences highlighted in solid black superimposed over the base plan in gray in accordance with the proposed solution:

FIG. 21 is a schematic pictorial view of a touch screen interface illustrating different types annotations in accordance with the proposed solution;

FIG. 22 is a schematic pictorial view of a touch screen interface illustrating an annotation context menu in accordance with the proposed solution;

FIG. 23 is a schematic pictorial view of a touch screen interface illustrating a free hand annotation in accordance with the proposed solution;

FIG. 24 is a schematic pictorial view of a touch screen interface illustrating annotation association with a user in accordance with the proposed solution; and

FIG. 25 is a schematic pictorial view of a touch screen interface illustrating a virtual ruler in accordance with the proposed solution,

wherein similar features bear similar labels throughout the drawings. Reference to “top” and “bottom” qualifiers in the present specification is made solely with reference to the orientation of the drawings as presented in the application and do not imply any absolute spatial orientation.

### DETAILED DESCRIPTION

### Electronic Collaboration Apparatus Hardware and Components

Draftsmen, architects, and engineers alike prefer the use of a drafting table for both design and collaboration. Interacting with a horizontal surface tends to limit collaboration as only a limited number of individuals can gather around, while interacting with a vertical surface tends to be tiring on the arms. In accordance with an aspect of the proposed solution there is provided an electronic collaboration table including a tactile human-machine interface at a fixed angle of about 40°. An angled electronic collaboration table is suited for interaction while standing as well while seated.

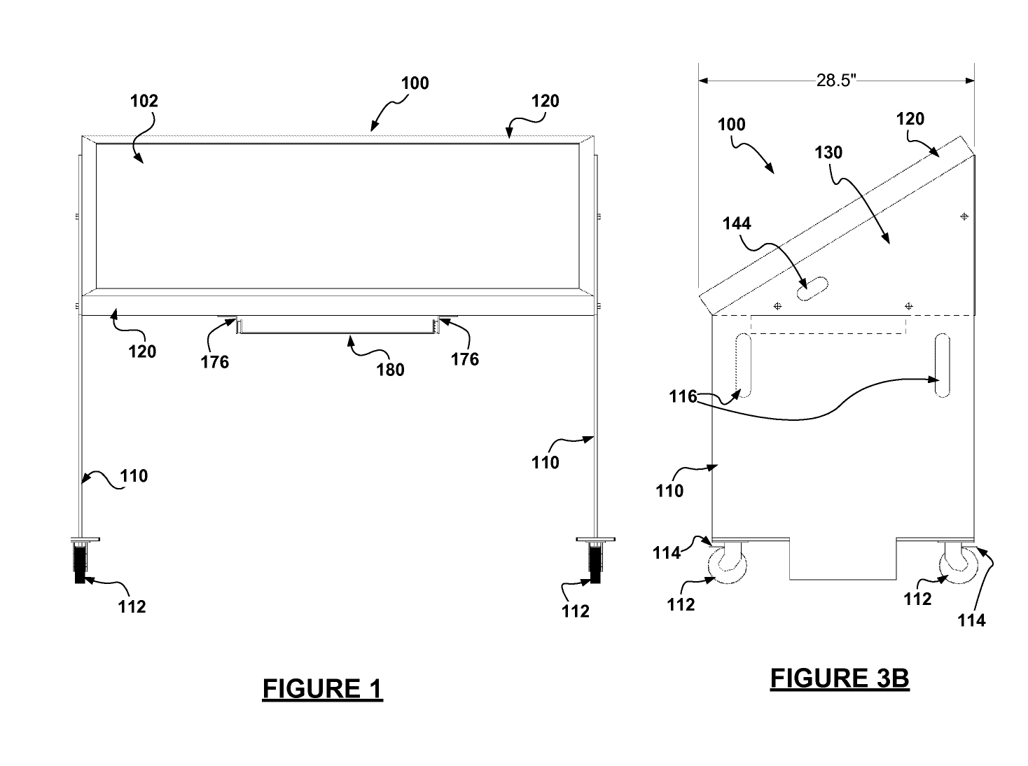

In accordance with an implementation of the proposed solution FIG. 1 illustrates an electronic collaboration table which includes a tactile human-machine interface. Electronic collaboration table 100 preferably includes a touch screen interface 102. Without limiting the invention, the touch screen interface 102 can include a touch detection system overlaid on top of a display. The display can include a computer display or a television screen, preferably a flat screen variety thereof. A variety of flat screen technologies are available including, but not limited to: plasma,

Thin Film Transistor (TFT), Liquid Crystal Display (LCD) neon or Light Emitting Diode (LED) back lit, an e-Inc display (Plastic Logic Ltd.), organic-LED display, etc. and projected displays. The touch detection system can include a capacitive layer, an Infra-Red (IR) beam interrupt grid, an IR field plate, etc. From a collaboration perspective, the touch screen interface 102 preferably includes a large screen LCD/LED display. Preferably, the touch screen interface 102 has a wide screen aspect for example 16×9 or 16×10 in landscape orientation with a viewable area diagonal size between 45 in and 65 in. Form a cost perspective, touch pickup can be economically provided by an IR beam interrupt grid implemented into a frame. From practical considerations, typical building doors through which the electronic collaboration table 100 is needed to pass are in the range of 30 in to 32 in wide and smaller; considering minimum clearance, the maximum depth of the electronic collaboration table can be about 28.5 in. It is understood that even 45 in wide aspect flat screen television when used to implement the electronic collaboration table 100, with a bezel adding at least 1.5 in to at least one lateral dimension of the electronic collaboration table 100 (as shown in FIGS. 3A and 3B) would still not comfortably fit through a 30 in doorframe with the door attached and which only opens 90° as the door thickness reduces clearance. A 55 in diagonal full high-definition flat screen LCD/LED television currently provides a best compromise between size, resolution, cost, availability and ergonomic considerations providing an electronic collaboration table 100 having a touch screen human-machine interface inclined at about 40° from the horizontal while respecting the 32 in depth requirement (including the bezel described hereinbelow). It is noted that the 40° inclination of the electronic collaboration table 100 is preferable for proper ergonomic interaction with a 55 in diagonal touch screen interface 102 at a chosen height by an average user in a standing and/or a sitting position. Furthermore, as illustrated in FIG. 3A, a 55 in diagonal screen LCD/LED television at 40° from the horizontal fits on top of a 27 in depth side support member 110 allowing an ample 1.5 in space to encase the television and the touch detection system technology employed in a bezel 120 as illustrated in FIG. 3B. It is understood that the acute angle can be selected as a function of the height of the electronic collaboration table 100. the standing height of a user, the sifting height of the user, the frame height of the flat screen display and the bezel depth. Preferably such bezel 120 further provides protection from mechanical side impact, while a transparent plate or film preferably provides protection from mechanical impact received by the flat screen surface directly. The IR beam grid frame can be in the order of 0.5 in thick or less.

Side support member 110, can include a metal plate or a framework and casters 112. Selected casters 112 preferably include locks 114 for preventing slidable movement of the electronic collaboration table 100 across a floor. When the side support member 110 is a plate, optional cutouts 116 can provide handles for maneuvering the electronic collaboration table 100.

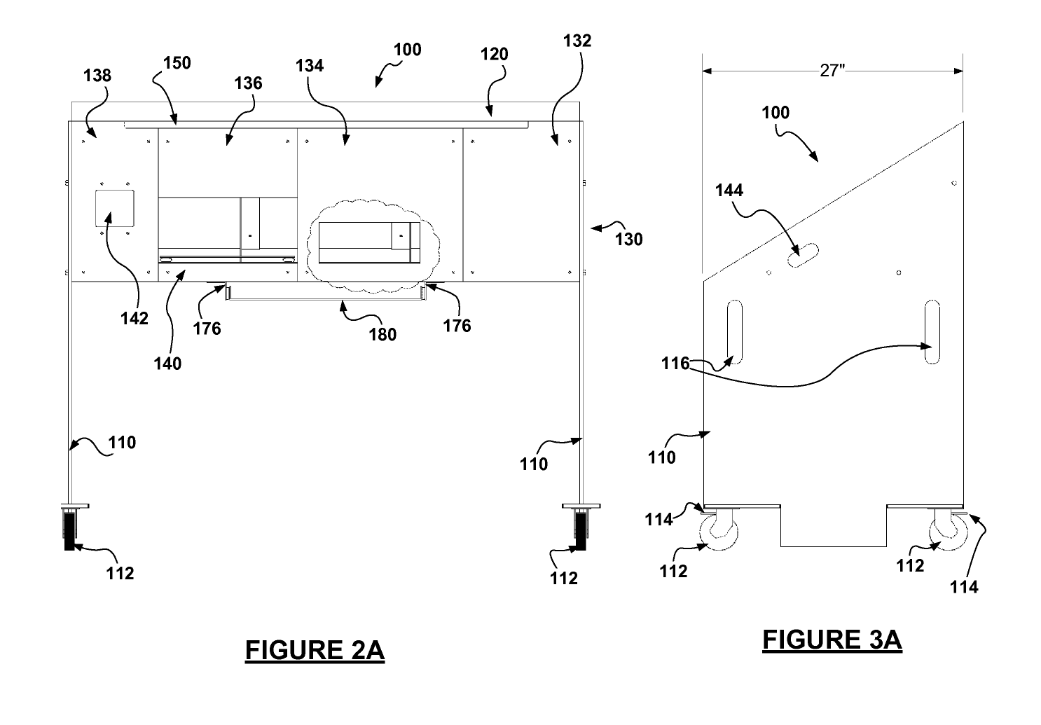

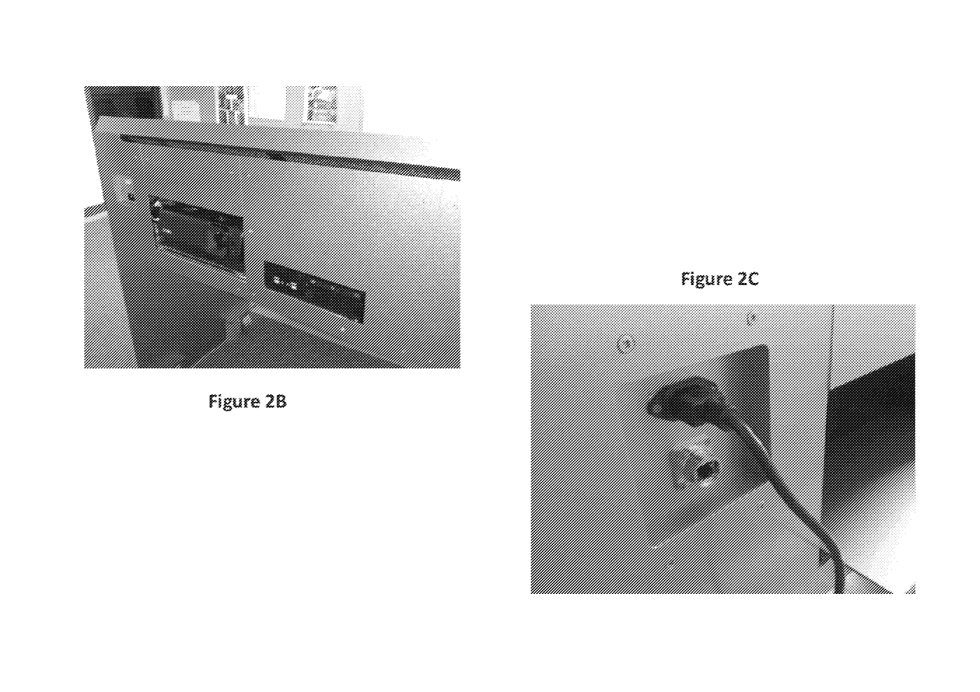

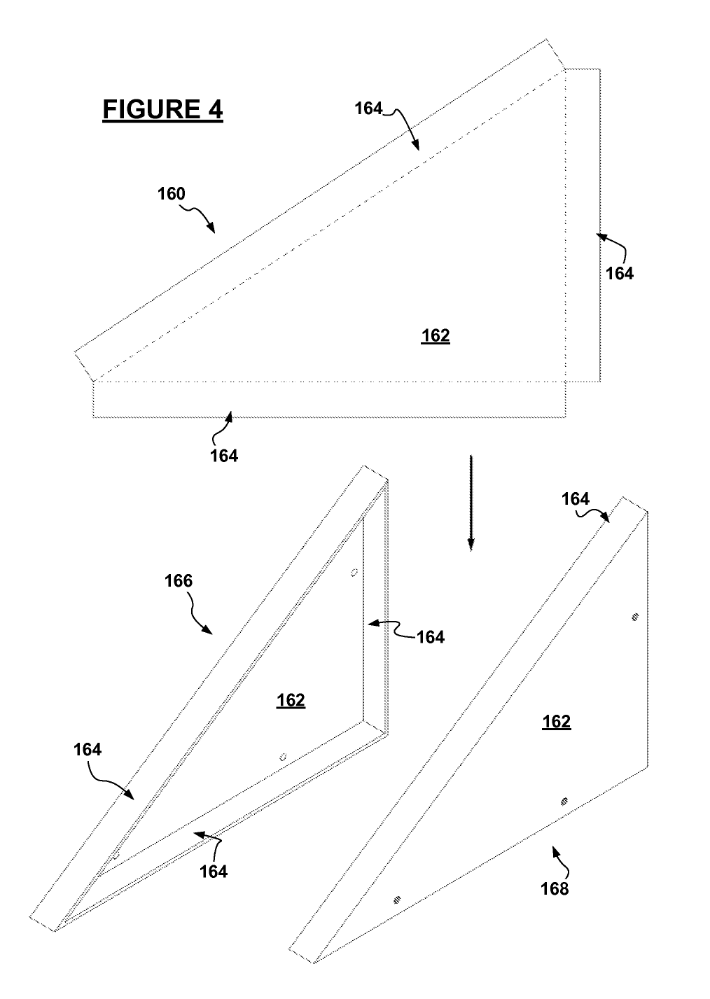

With reference to FIG. 2A, a space 130 under the touch screen interface 102 houses electronic components, including electronic components enabling for example, but not limited to: the touch screen human-machine interface 102, collaboration functional components and optionally a secondary display component for example a projector display. For these and other purposes, space 130 is covered with a number of panels 132, 134, 136 and 138. For example, panels 132 and 134 can provide access to collaboration enabling functional components such as, but not limited to a computer (not shown), memory/persistent storage, etc. Preferably the computer is a small foot print computer or a low/thin from factor computer. More preferably, however without limiting the invention thereto, the computer can be implemented in fan-less fashion to reduce noise and vibration while providing adequate heat dissipation. For certainty, the proposed solution can equally be implemented by adhering to PC104 standards for low power consumption and high vibration resilience. A PC104 compliant configuration can address a variety of shortcomings of industrial environments including, but not limited to: providing a sealed electronic collaboration table 100. For example, sealed operation can at least employ finned back panels 132 to 138 for free convection cooling without impeding user gathering in front and on the sides of the electronic collaboration table 100.

For operation in non-industrial environments, that is non-requiring sealed operation, back panels 132 to 138 can be configured to form a vent slot 150 under bezel 120 to allow for heat dissipation by convection. Heat dissipation by convection enables implementation of the proposed solution employing components enabling improved computation as required by various implementations/deployments.

Back panel 136 can be configured to accommodate a projector shown in FIG. 2B as a secondary display device mounted on a bracket/shelf 140. Back panel 138 can be configured to cover power distribution components of the electronic collaboration table 100, for example, but not limited to power conditioning, fuses, a backup power supply, etc. Cutout 142 of panel 138 provides power entry jack(s) and preferably grounding attachment as illustrated in FIG. 2C. For certainty, the invention is not limited to the use of a power backup'ed desktop type personal computer, a thin client or workstation; a laptop or tablet computer can also be employed with built-in battery backup. For the reminder of the description when reference is be made to a collaboration computer, such collaboration computer is intended to include any of the above computer examples, a tablet, a Personal Information Manager, etc. processing tactile input from the touch detection system and selectively displaying an output at least on the touch screen interface 102. Employing a laptop or tablet (computer) includes using a docking station to interface the collaboration computer to the rest of the electronic collaboration table 100. The use of a power backup power supply as an electrical power distribution component provides support for the incorporation of additional storage, such as but not limited to a Redundant Array of Independent Disks (RAID), either directly connected to the computer or in Network Attached Storage (NAS) form. With reference to FIGS. 2A and 2B an access cutout 144, on the side of the electronic collaboration table 100, provides access to a network jack and removable storage slot(s). Removable storage can include memory cards (CF, SD, MMX, Memory Stick, etc.), and Universal Serial Bus (USB), Fire Wire etc. compliant storage. For certainty, the invention is not limited to the type of external storage employed.

FIG. 4 illustrates, as an example, sheet metal manufactured end caps for electronic components space 130 illustrated in FIGS. 2A and 3B. A metal sheet 160 is cut out to define a substantially triangular interior region 162 having an acute vertex of about 40° and tabs 164. Sheet metal bending can be employed to make left-hand-side end cap 166 and right-hand-side cap 168.

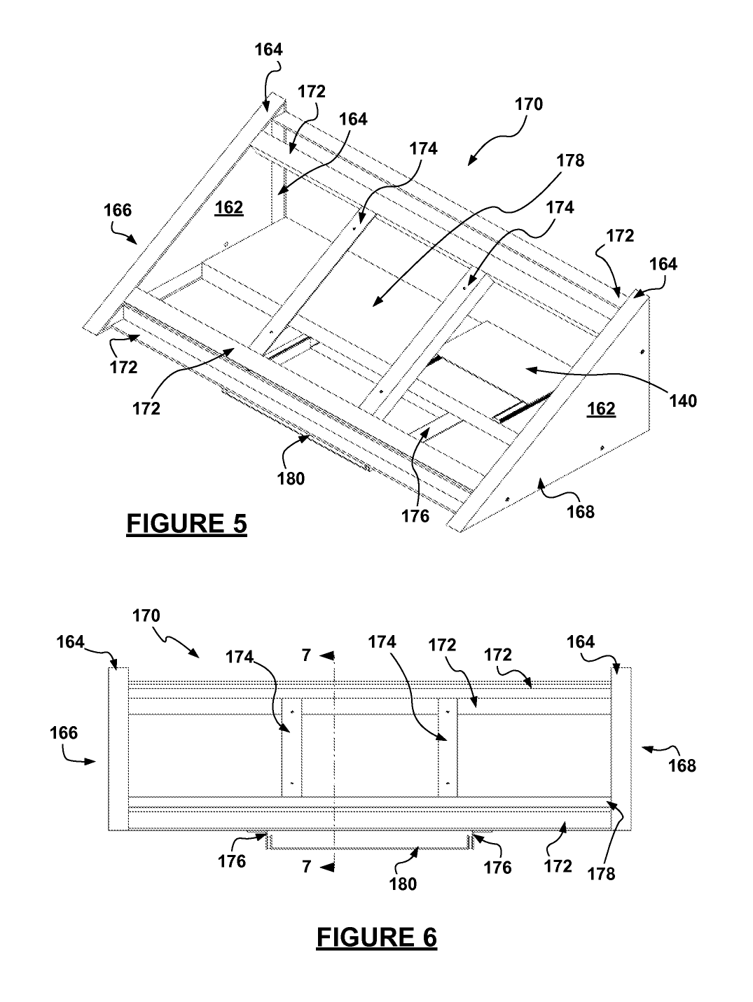

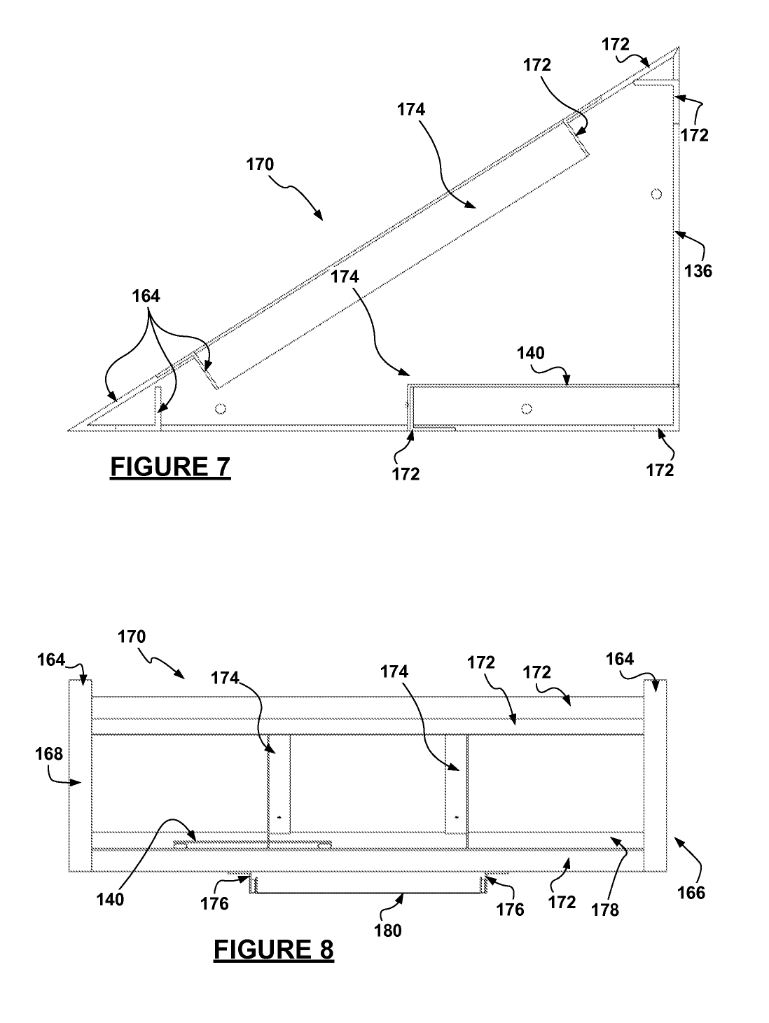

FIGS. 5 to 8 are schematic diagrams illustrating a support framework in accordance with an embodiment of the proposed solution. The support framework 170 includes a number of horizontal support members 172 extending between end caps 166 and 168. Horizontal support members 172 have a variety of cross-sections further configured to fixedly engage at least one flat screen support member 174. Depending on the depth of the bezel 120 and the thickness of the touch surface, a portion of the flat screen display implementing the touch screen interface 102 can extend into space 130 in which case, horizontal support members 172 are configured to fixedly engage the at least one flat screen support member 174 such that the at least one flat screen support member 174 is recessed into space 130.

At least one electronic component support member 176 is configured to fixedly engage horizontal support members 172 to enable at least one equipment shelf 178 to be supported thereon or on a combination thereof. At least a subcombination of at least one horizontal support member 172, electronic component support member 176, and equipment shelf 178 can be configured to provide support for projector bracket/shelf 140, support which can include, but is not limited to: fixed and slidable engagement. At least a subcombination of at least one horizontal support member 172 and electronic component support member 176 can be configured to provide support for a keyboard shelf 180, support which can include, but is not limited to: slidable and rotational engagement.

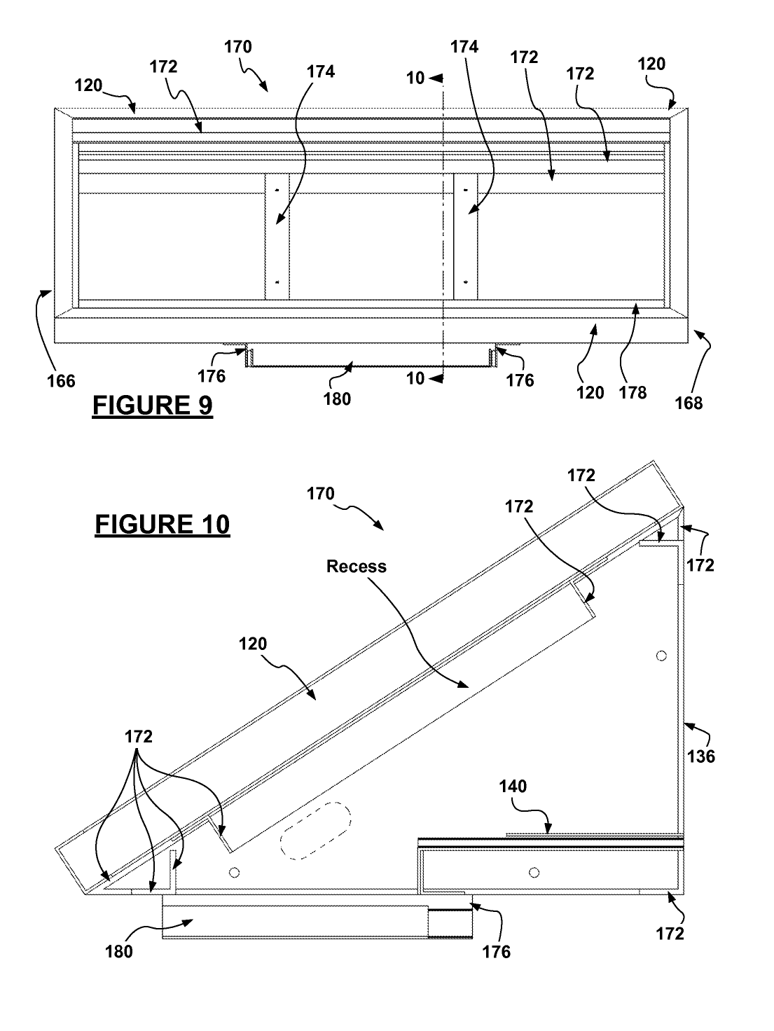

FIGS. 9 and 10 illustrate the support framework and bezel combination in accordance with an embodiment of the proposed solution. Bezel 120 is fixedly engaged to horizontal support members 172 and upper tab 164 of end caps 166 and 168.

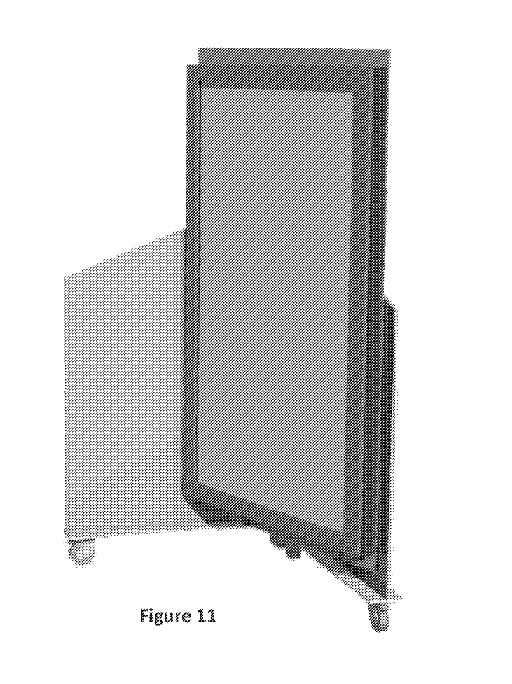

FIG. 11 illustrates a reconfigured electronic collaboration table enabling transport thereof to negotiate tight spaces. With reference to FIGS. 3A, 3B, 4, 5, 7 and 10, the support framework 170 is fixedly connected to the support members 110 via fasteners, preferably such fasteners include hand operable knobs. The use of hand operable knobs for the fasteners, and corresponding anchoring orifices in the support framework, and preferably in support members 172 and 176, enable reconfiguration of the electronic collaboration table 100 with the touch screen interface 102 having a vertical orientation.

### Dynamic Zooming

A large number of Computer Aided Design (CAD) software applications exist each purposefully designed for the different disciplines required to complete projects large and/or small. It has been discovered that electronic collaboration benefits from a unified electronic plan source, for example provided by plans output in Portable Document Format (PDF) and particularly output in the vector graphics specification variety of PDF. Without limiting the invention, the raster bitmap specification variety of PDF can also be accommodated. For certainty, the invention is not limited to employing PDF plan source, and references to PDF vector graphics specification is used only for brevity of description herein. Other electronic plan specifications exist and can be used as well, for example plotter (specification) files.

It has been discovered that electronic collaboration greatly benefits from zoom-in and zoom-out functionality. In accordance with an embodiment of the proposed solution, vector graphics specification files, such as vector graphics PDF, are converted to an eXtensible Markup Language (XML) format. The conversion can be provided via execution of logic instructions by the collaboration computer. The conversion provides source format independence and content handles to select the content. While vector graphics PDF specification is generally used, different versions of PDF writers generate vector graphics PDF specification files having differing formats. The XML conversion recasts these vector graphics specifications into a unified vector graphics specification for example by encapsulating vector graphics specifications between XML tags. Advantageously, XML converters can be provided for each PDF version currently in use and for each future version to be deployed as and when deployed. It is understood that certain versions of PDF writers, for example the Adobe Acrobat 9 Pro™ provided by Adobe Systems, can include XML content into PDF files. Via the XML converter described herein, the proprietary Adobe Systems XML specification (and others) can be recast, to the extent needed, to XML for use with the proposed solution or disregarded in order to improve collaboration responsiveness. The XML tags of unified vector graphics specification can be employed as content handles to select content.

In accordance with the embodiment of the proposed solution, XML encapsulated vector graphics specifications can be employed as database entries corresponding to viewable objects for display on the electronic collaboration table 100/touch screen interface 102. For example, a vector graphics circle specification in a PFD specification can be described by an x-y off-set of the center of the circle and a radius “c 1371, 2343, 761” and a corresponding XML database entry for example can be (in very simplified form): <circle> <centre offset> <x>1371</x> <y>2343</y> </center offset> <radius>761</radius> </circle>. Different versions of vector graphics PDF files of the same circle would for example have a different identifier “c”, “circ”, “circle” and/or the off-set may be specified in a different order ‘x, y’ or ‘y, x’, for example depending on portrait or landscape page orientation, and the radius may be specified before or after the off-set. As well each vector graphics PDF specification file may specify a different magnification factor which can be taken into consideration in the XML conversion.

In accordance with the proposed solution, the interactivity software of the electronic collaboration table 100 is configured to selectively display the contents of the XML database on the touch screen interface 102. For example, the entries XML database including a single plan (converted from a vector graphics specification) can be displayed on the touch screen interface 102 by applying a scaling factor to each positional offset and size specification in each database entry, the scaling factor causing the plan to fit within the viewable area of the touch screen interface 102 in flat screen coordinates at the resolution of the flat screen of the touch screen interface 102. It is understood that besides a scaling factor, a rotation and a flip factor can further be employed to account for the orientation the touch screen interface 102 with respect to a viewer. The display of vector graphics XML specification database entries can be achieved by a raster graphics conversion of the vector graphics specification at the resolution of the flat screen, processing step also referred to herein as rasterization, which by enlarge entails finding out which screen pixels correspond to points on lines, arcs, splines, etc. in the XML plan specification. Rasterization is performed by the electronic collaboration table computer and/or a video processor thereof. The rasterized graphics representation can be stored in memory associated with the video processor and/or computer memory.

Touch human machine interactivity software executes (on the computer/tablet) enabling tap and gesture based selectivity and manipulation of displayed content. In accordance with an embodiment of the proposed solution, interactivity with the (tactile) human-machine interface via the touch screen interface 102 of the electronic collaboration table 100, including through, but not limited to: taps, single-touch gestures and multi-touch gestures, causes at least one of a shift, scaling factor and/or rotation to be applied to the raster graphics representation of the plan followed by a re-rasterization of the database entries to implement at least one of a pan, zoom-in/out, and rotation of the displayed plan. In accordance with the proposed solution, applying shift, scaling factor and/or rotation is performed only on a viewable portion of the displayed raster graphics representation of the plan (at the beginning of the interaction) and the subsequent rasterization step is performed only on database entries describing objects viewable in a final viewable box corresponding to the touch screen interface 102. The XML vector graphics database representation provides selectivity of database entries describing objects viewable in a final viewable box corresponding to the touch screen interface 102 via database dips based on final viewable box coordinates.

A substantially real time animated output is provided while the at least one pan, zoom and/or rotation transformation corresponding to the gesture is performed on the raster image in (computer or videocard) memory which can be incomplete behind a pan gesture, incomplete around the touch screen interface edges during a rotation, of a successively lower resolution during zoom-in, and incomplete around the touch screen interface edges during a zoom-out. Re-raseterization of can be performed at the end of the gesture and/or during a pause within a gesture. The suppression of re-rasterization during the animation of a displayed image transformation and the selective re-rasterization provides substantial improvements in human-machine interface response.

### Virtual Keyboard

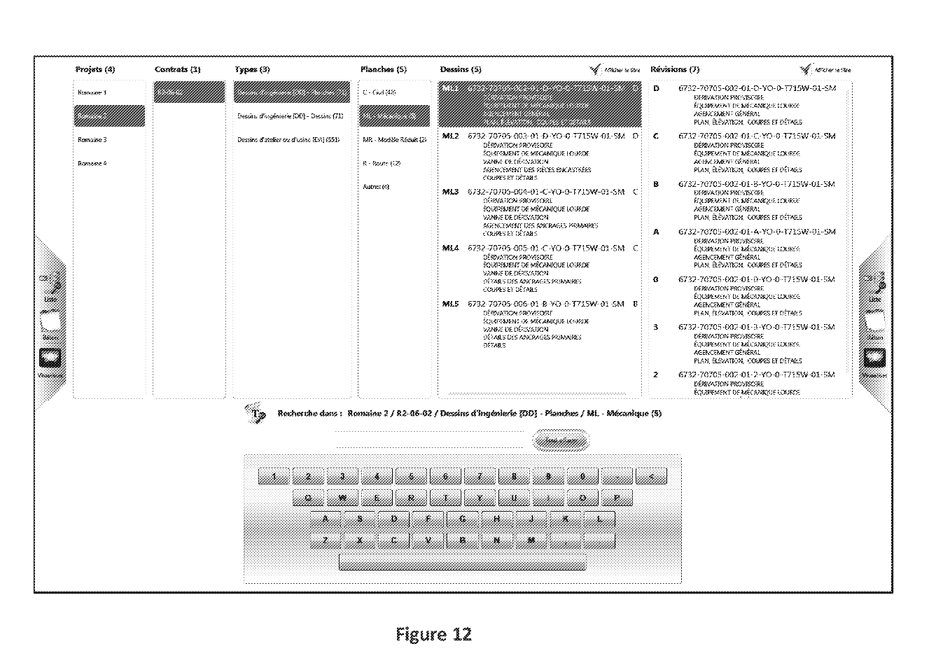

Besides a hardware keyboard employed with keyboard tray 180, the human-machine interface provided by the interactivity software via the touch screen interface can also display and provide a virtual keyboard, preferably a context sensitive virtual keyboard. The context sensitive virtual keyboard can be configured to selectively display, and provide interactivity with, a relevant key set/key shortcuts corresponding to a task currently performed via the touch screen interface 102. For certainty, and with reference to FIG. 12, a virtual keyboard includes an actual keyboard looking keypad and special purpose buttons such as a “Go” button besides an entry field.

In accordance with an implementation of the proposed solution, the virtual keyboard can be selectively displayed, shifted, rotated and/or scaled. Zooming-in/out of the virtual keyboard can be configured to display additional or to omit other than necessary keys for the current context.

### Menus

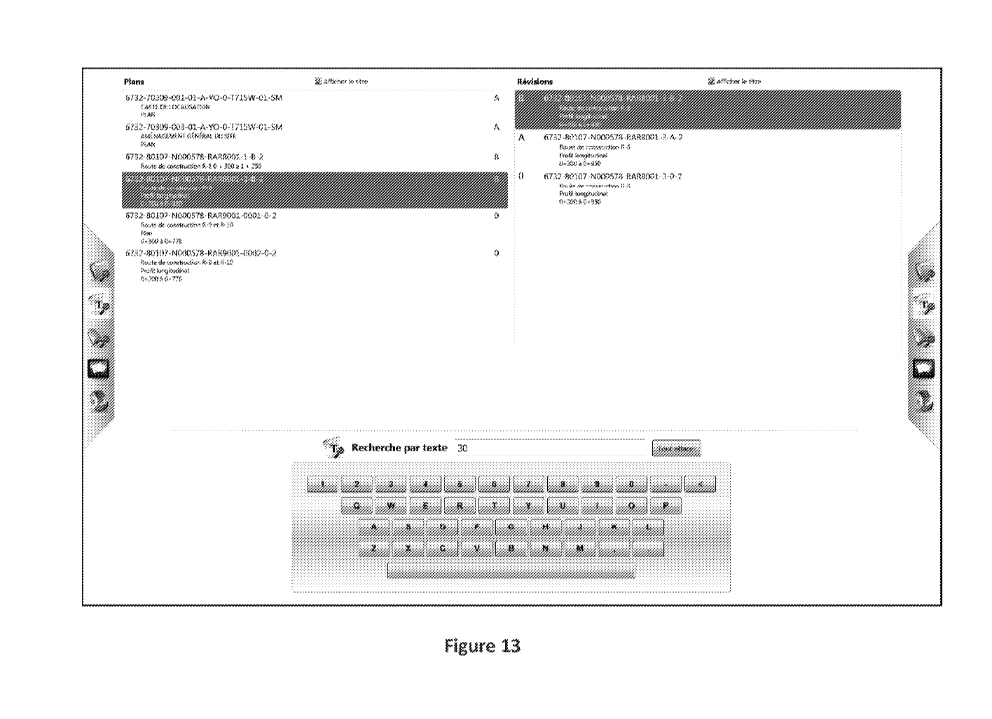

Besides a virtual keyboard the human-machine interface provided by the interactivity software via the touch screen interface can also display and provide a menu, preferably a context sensitive menu. The context sensitive menu can be configured to selectively display, and provide interactivity with, a relevant functional set of button/shortcuts corresponding to possible tasks currently performable via the touch screen interface 102. In accordance with one implementation of the proposed solution, and with reference to FIG. 12, two copies of the menu can be displayed on either side of the touch screen interface 102. The multiple copies of the menu facilitate improved interactivity in view of a number of aspects including: the proximity of at least one menu to an area of interest on a large touch screen interface 102 provides quick access to menu functionality with reduced distraction; the left-hand side and right-hand side menu availability accommodates both right and left handed users; and the multiple menus enable collaboration between individual users gathered around the electronic collaboration table 100 reducing the need to stretch across the electronic collaboration table 100 to access menu functionality. FIGS. 13, 21 and 22 also show a menu along the bottom edge of the touch screen interface 102. In accordance with another implementation of the proposed solution the menu(s) can be configured to be selectively hidden to provide a more extensive display of the active display region displaying at least one plan. In accordance with another implementation of the embodiment, the menu can be selectively torn away and selectively positioned to provide both access to functionality and clear view of the at least one plan displayed on the touch screen interface.

### Gesture Freeze Button

It is recognized that human expression includes gesticulating; combined with touch-based interactivity provided via the touch screen interface 102, gesticulating can lead to unintended displayed plan pans and other undesired outcomes. In accordance with an implementation of another embodiment of the proposed solution, a gesture freeze button or a gesture freeze region can be provided to toggle gesture pickup and interpretation. Preferably a non-displayable gesture freeze region is employed in order to provide unhindered observation of the touch screen interface 102 viewable area. When a gesture freeze button is employed, pressing the gesture freeze button can cause a combination of, and preferably all: keyboards, menus and the gesture freeze button to disappear to reveal the largest viewable area of a current plan for collaboration. In the latter implementation, the entire touch screen interface 102 except for the gesture freeze region (not necessarily where the gesture freeze button was displayed) is non-responsive. Touching the gesture freeze region again restores interactivity. For certainty, the invention is not limited to a virtual gesture freeze button, a physical button can also be provided on the electronic collaboration table 100 for this purpose.

### Document Management

Collaboration entails both information in plan drawings, as well information about such plan drawings. For example, plan views of a semiconductor layer can include a number of revisions as well customer design specification plans and verification plans. In electronic form, information about such plans in maintained in plan metadata, file names, file naming conventions, etc. It has been discovered that information about applicable plans can further enhance ease of electronic collaboration. For example, information specifying applicable plans represents semantic metadata including rules specifying that an architectural set of plans requires plumbing/drainage plans whereas a semiconductor chip layout set of plans would not. In accordance with a further aspect of the proposed solution, both vector graphics plan specifications, plan metadata, file names, file naming conventions, semantic metadata, etc. is converted to an XML format providing a unification of plan related information management and processing.

In accordance with the proposed solution, FIG. 12 schematically illustrates a pictorial representation of a XML metadata enabling hierarchical browsing of a number of plans, for example by project, contracts, type, layers, plan, revisions, etc. The hierarchical presentation can be guided by semantic metadata. FIG. 13 schematically illustrates collapsing the hierarchical metadata view to relevant hierarchy levels for example for the purposes of plan selection. Of worthy note is the context sensitive nature of the menus, the appearance of which is illustrated as changed with respect to that shown in FIG. 12.

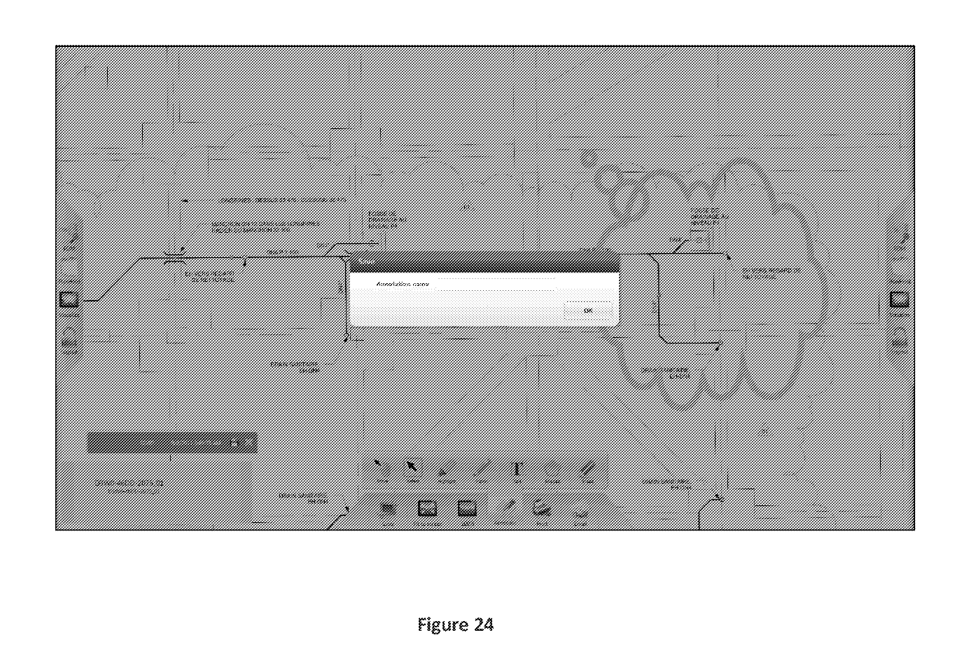

The invention is not limited to pre-specified metadata, XML entries can be generated during the collaboration process, for example XML database entries can be maintained specifying the source of a plan “from client X” and “added to database by user Y”. FIG. 24 illustrates an interface widget via which a user name is specified. As well, at the completion of a collaboration session, XML metadata tags can be associated with reviewed and revised plans specifying “submitted for review/approval/change implementation to Z” and/or “discarded/no longer current/for reference only/on stand-by/pending event/etc.” Without limiting the invention thereto, XML metadata tags can be employed corresponding to a plan review and revision process.

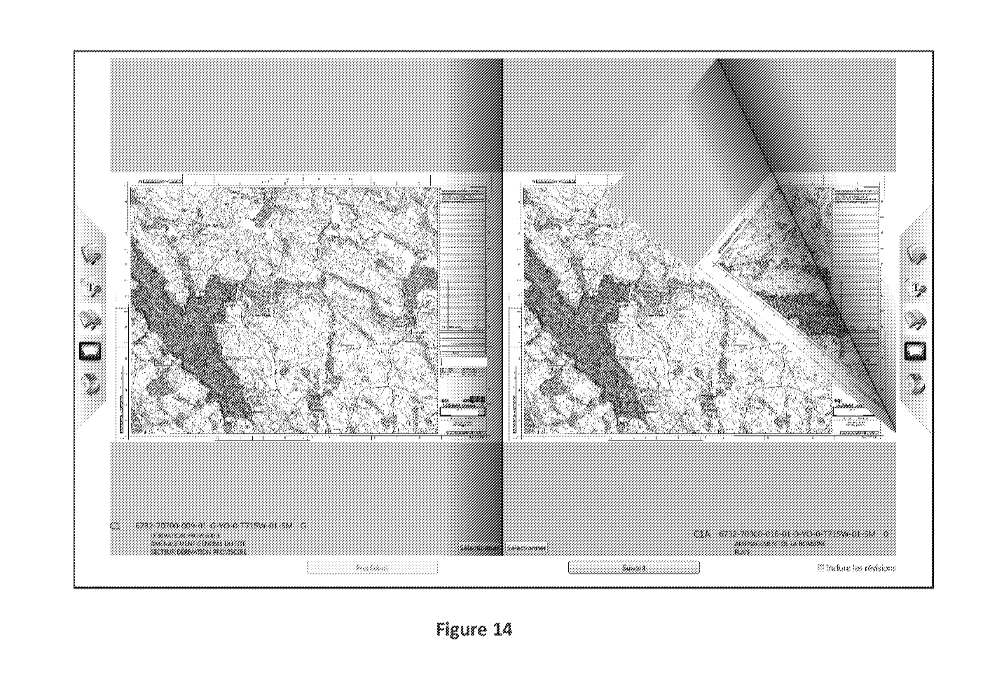

For certainty, the invention is not limited hierarchical perusal of metadata information; FIG. 14 illustrates page flip type perusal through a folio via gestures. In accordance with an embodiment of the proposed solution, the selection of plans/folios, for example as illustrated in FIGS. 12 and 13 can be employed to generate a combined virtual folio. A virtual combination of folios can be perused by page flip as if bound together. In accordance with yet another implementation of the proposed solution, tap and gesture based interactivity with the (tactile) human-machine interface via the touch screen interface 102 of the electronic collaboration table 100, including but not limited to: taps, single-touch gestures and multi-touch gestures, can be employed to shift, scale and rotate representative plan images on folio pages.

In accordance with an implementation of an embodiment of the proposed solution, an order of plan selection can be stored per collaboration session and/or in a generic list as a browsing history. In accordance with another implementation of another embodiment of the proposed solution, the frequency of plan selection can be specified in order of highest frequency first in an ordered list of plan favorites.

### Plan Comparison Functionality

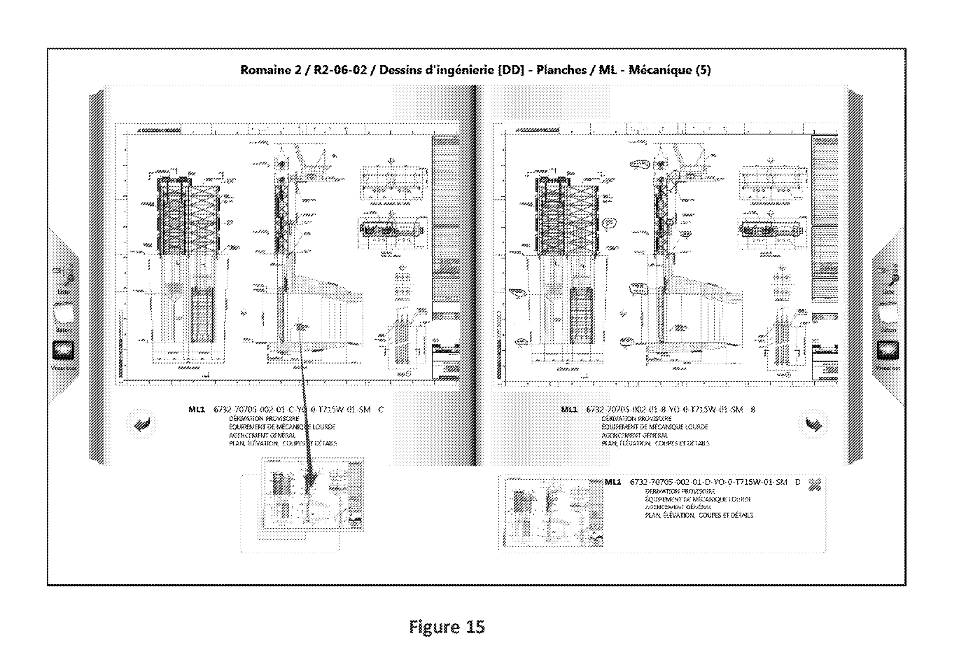

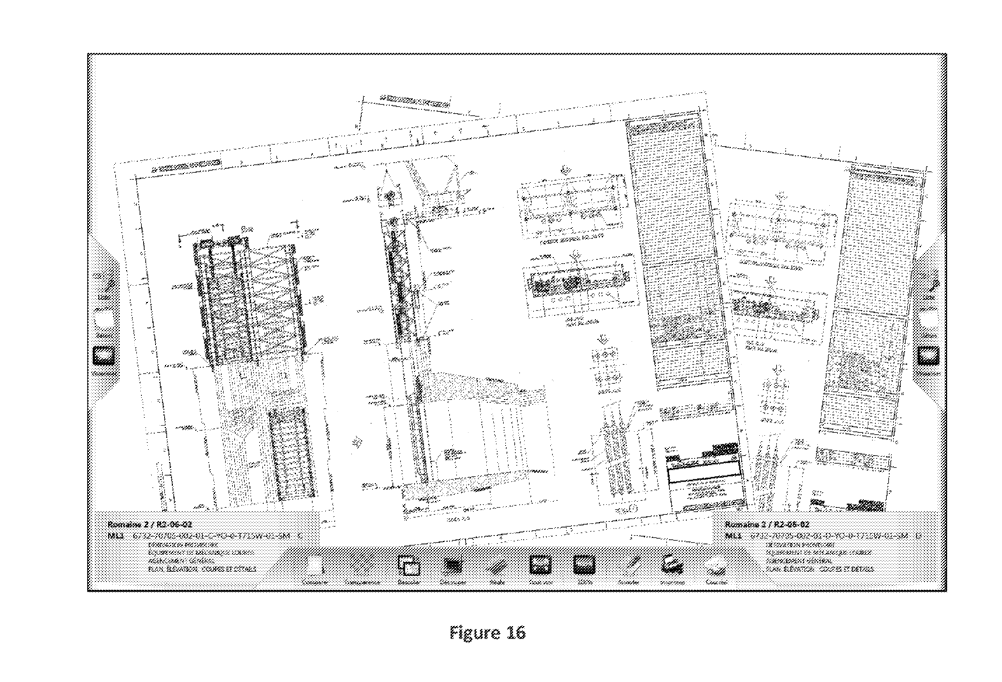

Collaboration almost always entails working with multiple versions of a plan, related plans and, if not, results in the creation of a plan modification. For example, FIG. 15 illustrates a drag-down gesture for selecting a plan (for comparison), in accordance with a preferred embodiment of the proposed solution; and FIG. 16 illustrates a selected pair of plans for comparison. Of worthy note is the appearance of another context sensitive menu along the bottom of the touch screen interface 102 providing access functionality applicable to interacting with a pair of plans, in accordance with the embodiment of the proposed solution.

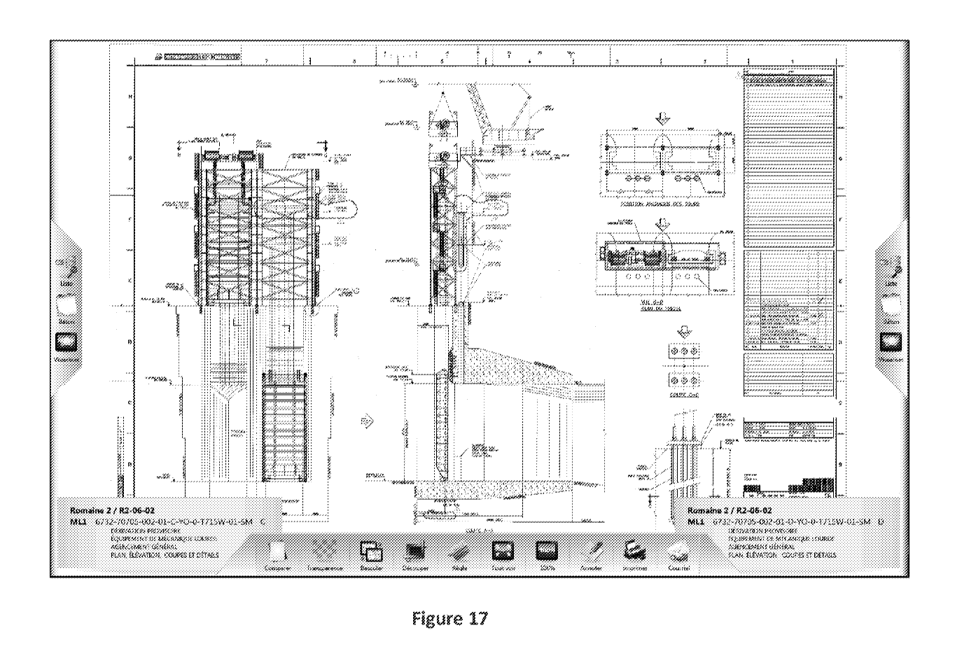

It is apparent from FIG. 16 that the typical complexity of plans, on paper or in PDF form, provides little in the way of identifying differences. It is recognized that currently paper plan comparison requires plan printing on tracing paper and/or scanning, both of which are time consuming and inconvenient. In accordance with a further aspect of the proposed solution transparent plan superposition and comparison is provided. FIG. 17 illustrates an example of a transparent superposition of the two selected plans illustrated in FIG. 16. Metadata indicating which plans are being compared can be illustrated in the lower left and right corners of the touch screen interface 102. Correct registration of the two plans is dependent on the finding of correct values for unknowns such as: relative origin offset between the two plans, a correct relative scaling factor between the two plans and a correct relative rotation factor between the two plans.

In accordance with an implementation of the proposed solution the user is provided with touch screen interface 102 elements (gestures, menu items, widgets, etc.) for selecting a base plan of the two and for panning, rotating and/or zooming the other plan in order to perform manual/visual registration. The user can be further provided with touch screen interface 102 elements (gestures, menu items, widgets, etc.) for panning, rotating and/or zooming both plans together to help with and/or to improve registration between plans.

In accordance with another implementation of the proposed solution, blank regions in a displayed plan are treated as transparent, and superposition of the two plans includes a registration process. With vector graphics specification of each plan converted to XML, metadata in the title and legend block can be employed to determine a subcombination of the unknowns. For architectural plans, for example, a comparison between the scale blocks can provide a relative scaling factor, a comparison between the rosette blocks (compass rose) can provide a relative rotation factor, and absolute marker specifications in the plans can provide the correct relative origin offset when present. The same unknowns can be resolved by comparing alignment blocks for example on semiconductor plans. Absent such specifications and metadata, in accordance with another implementation of the proposed solution, brute force computation can be employed in performing pattern matching between plans. To the extent that such plans are marginally different, such computation computes a degree of correlation between the two plans with changes in the unknowns. Such correlation computation can take into account periodicity to avoid false positives. Some vector graphics specifications include an “array” operator which provides compact specification of repeated structures.

Significantly different plans and plans selected for the comparison of individual views therein may fare poorly at correlation analysis. As well, there are instances when the very reason for the plan comparison is to compare repeated features which are believed not to be exact duplicates. In accordance with yet another implementation of the proposed solution, correlational computation can be employed to aid manual/visual registration, with or without employing automated plan pre-registration, by performing correlational computation at the end of a gesture or during a gesture pause. The result of the correlation can be indicated, without limiting the invention, either in numeric form, percentage bar, color change, etc.

In accordance with another embodiment of the proposed solution, FIG. 17 illustrates registered plans with differences therebetween highlighted in cloud widgets. The invention is not limited to cloud type highlighting, other difference highlighting can also be achieved by color addition/subtraction when each plan content is displayed in a different color. Features not present in the other plan would display in the plan's color, and features present in both plans would displayed in a color sum or difference. Color sum and differences are understood in terms of numeric representation of colors in a color space (RGB, sRGB, etc.)

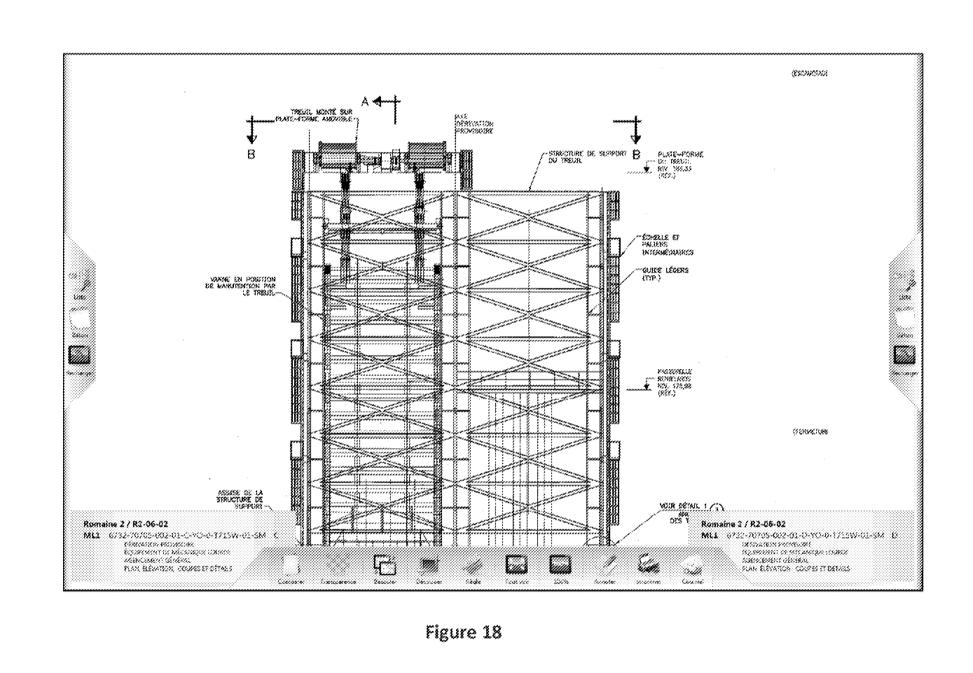

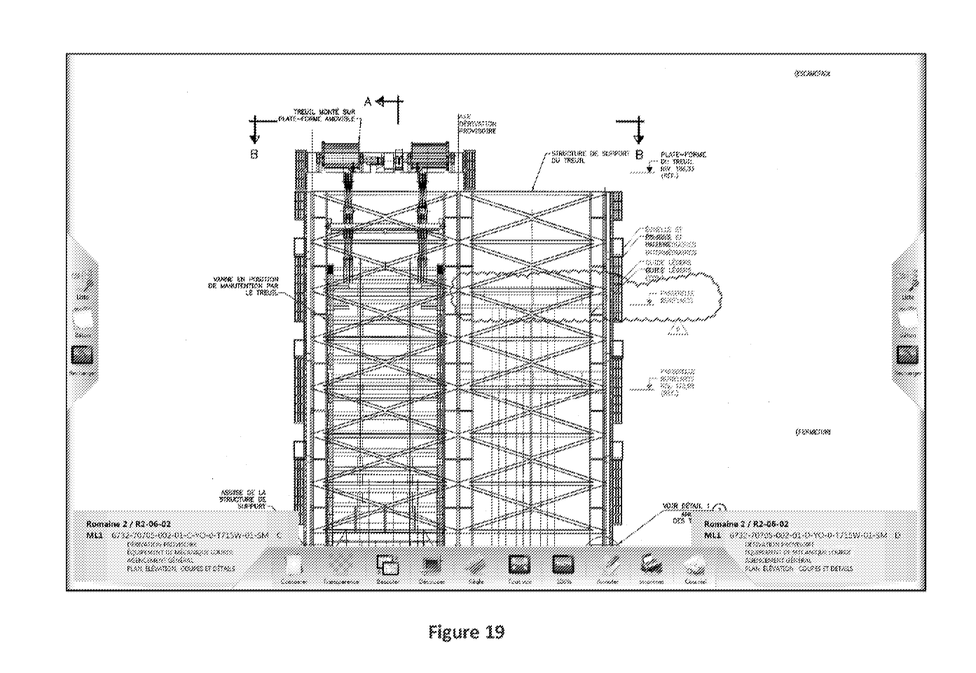

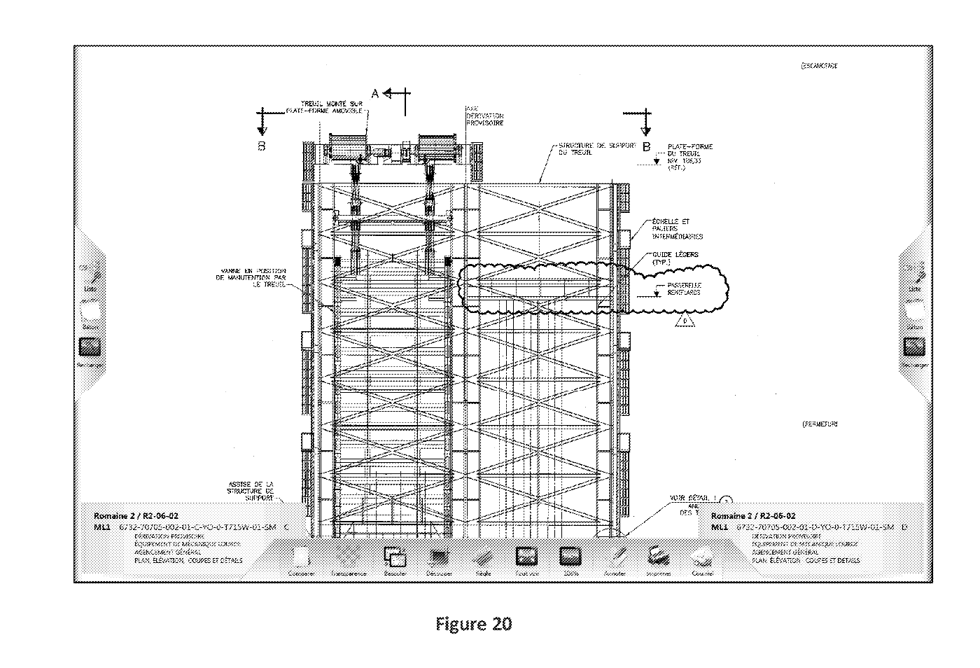

FIG. 18 illustrates a detail of a base plan in the pair. FIG. 19 illustrates the base plan detail in solid black superimposed over the other comparison plan in gray with differences highlighted in the comparison plan in gray. And, FIG. 20 illustrates the comparison plan in solid black with differences highlighted in solid black superimposed over the base plan in gray. A touch screen interface widget, for example a menu button can be interacted with to provide a continuous transition between the pictorial representations illustrated in FIGS. 18 to 20.

### Annotation

It is pointed out that, the cloud widget(s) illustrated in FIGS. 17, 19, 20, 21 and 23 are generated by electronic collaboration table software, and are referred to herein generally as annotations. Such plan differences annotations can be captured via XML specifications in the database as objects/entries, and can be associated (including being stored) with one or both compared plans. Differences annotations stored in a particular plan can further specify metadata such as, but not limited to: the plan, plan version, and plan creation date, against which such difference exists, as well metadata such as annotation creation date, user with whom the annotation is associated, etc.

Results of such collaboration typically lead to desired plan changes. In accordance with an embodiment of the proposed solution, touch screen interactivity functionality is provided for: annotating plans, plan annotation storage, annotation association with a user, and/or plan annotation association with at least one plan.

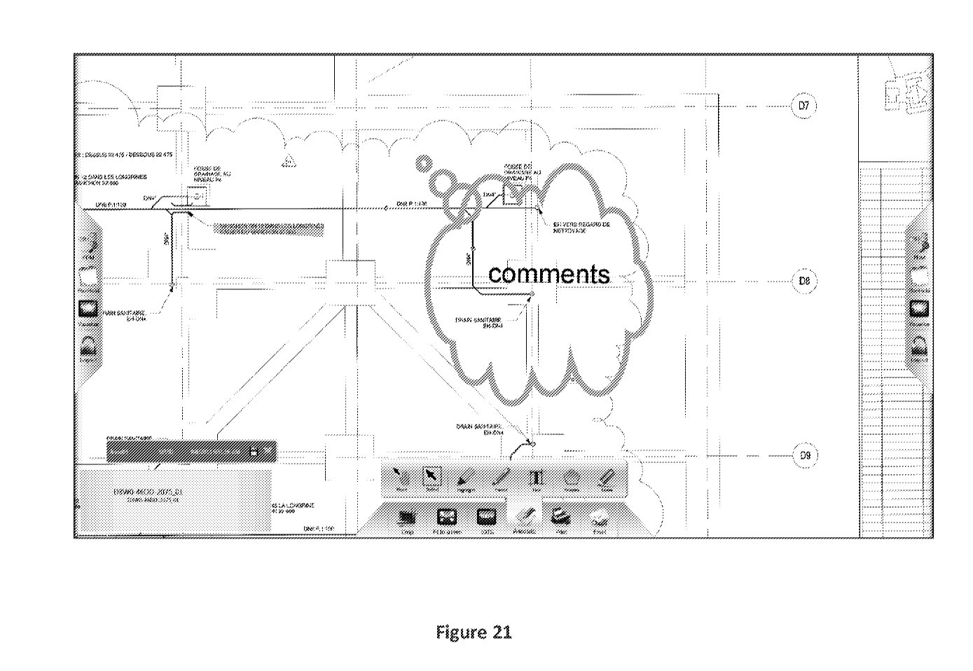

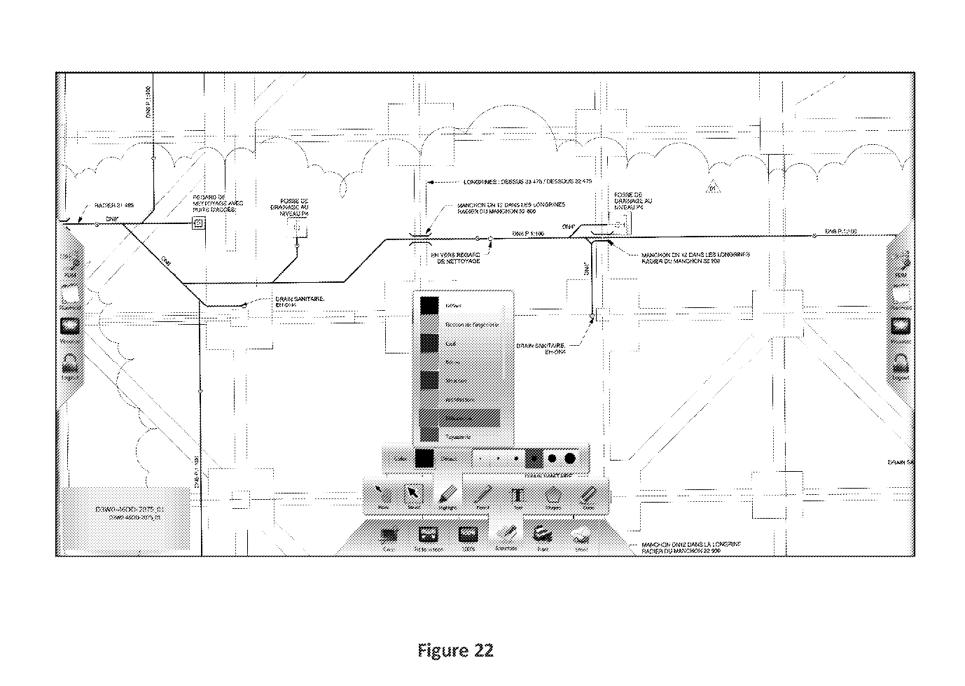

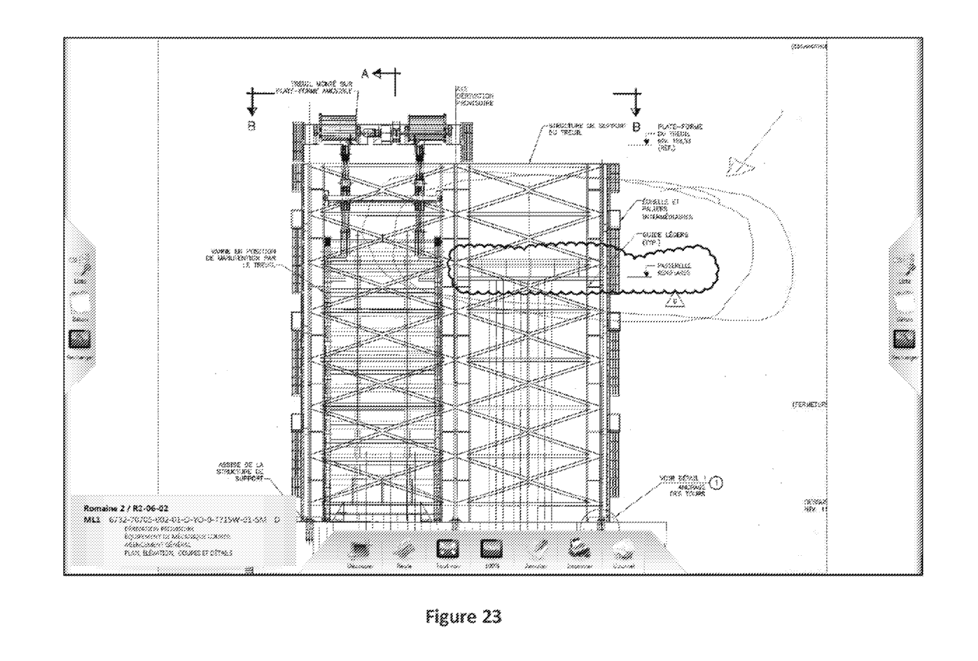

In accordance with the proposed solution, the differences annotations are a subset of a suite of annotation types provided via the electronic collaboration table 100. FIG. 21 illustrates highlight and comment annotations, and an annotation context menu. As illustrated in FIG. 22, annotations can have a shape selected from a list of shapes, as well with reference to FIG. 23 annotations can include free hand drawings. Colors and other annotation attributes can be selected via the annotation context menu for example as illustrated in FIG. 22. A highlight annotation is illustrated in FIG. 21 mimicking drawing with a highlighter on a paper plan.

In accordance with an embodiment of the proposed solution, annotations can be associated with a user of the electronic collaboration table 100. FIG. 24 illustrates a user specification widget, without limiting the invention, in the form of an alphanumeric field entry pop-up window. Annotations generated thereafter can, by default be associated with the current user. As illustrated in FIGS. 21, 22 and 24, a logout menu widget can be employed to stop associations being made with the current user and/or to change the current user.

### Virtual Ruler

Collaboration can entertain questions of size and measurement. For example “What would be the length of a brace needed between A and B?” As well reference to plans can be made for purposes of materials estimation. In accordance with yet another aspect of the proposed solution, a virtual ruler is provided to aid in materials estimation and other related project planning undertakings.

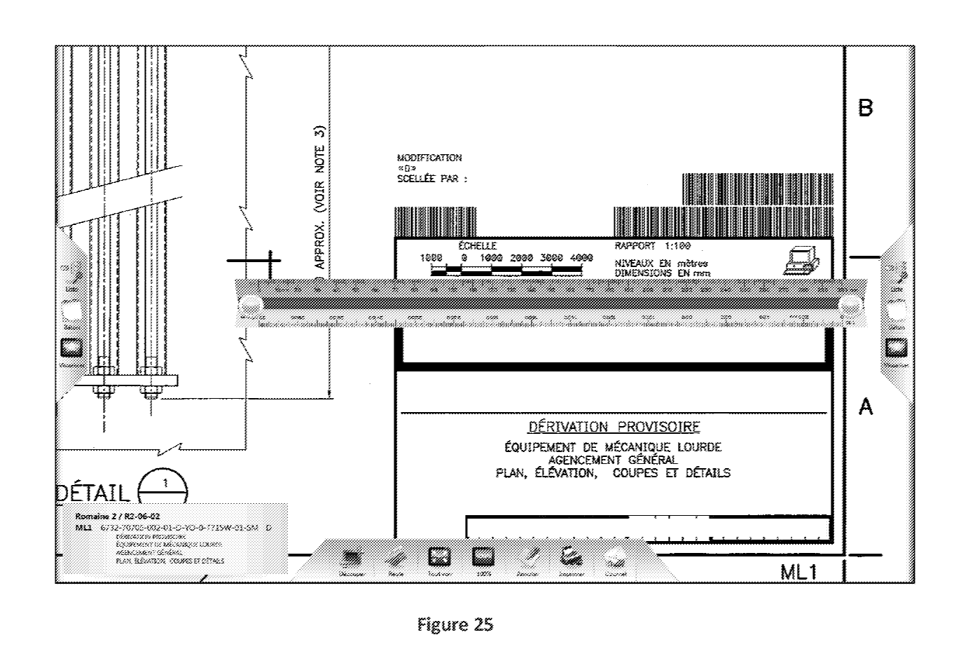

For example, FIG. 25 illustrates a virtual ruler, in accordance with yet another embodiment of the proposed solution. For example, the virtual ruler is invoked via interaction with one of a menu, a touch screen interface widget, a button (physical or virtual), a tactile sequence, a gesture, etc. The default virtual ruler as instantiated (or prior to instantiation) would have a default scale not necessarily related to the scale of any particular plan. The touch screen interface 102 can display indicia alerting a user to the fact that the ruler is the default ruler providing a straight line but not necessarily scaled measurement(s). Indicia can include a color, a particular fill, etc. In accordance with an implementation of the embodiment of the proposed solution, the scale block of a plan, as expressed in XML, can be taken into consideration in adjusting at least the display size, scale, marker pitch, major markers, minor markers, etc of the virtual ruler. In accordance with another implementation, the default virtual ruler can be slid, scaled and/or rotated via interaction with one of a menu, a touch screen interface widget, a button (physical or virtual), a tactile sequence, a gesture, etc. in order to align the virtual ruler with the scale block; for this purpose separate interaction is provided to pan, zoom and/or rotate the plan. In accordance with a further implementation of the embodiment of the proposed solution, XML information in the scale block of the plan can be employed to define a linear snap grid while the default virtual ruler also defines snap positions at the default pitch of the default ruler. Instantiation of the virtual ruler can first snap the virtual ruler to the scale block addressing at least in part relative orientation between the default virtual ruler and the scale block, and interaction with the virtual ruler causes the virtual ruler to stepwise snap to scale block addressing relative offset and relative scale therebetween. The former implementation has an accuracy increasing with the zoom factor used in scaling the virtual ruler, while the latter implementation has an improved accuracy.

In accordance with yet another embodiment of the proposed solution, a raster graphics plan specification can be processed along with vector graphics specified plans by loading the raster graphics plan in, scaling the virtual ruler to the raster graphics plan providing a relative scale and orientation specifications with respect to at least one vector graphics XML specified plans, and storing the relative scale and orientation in XML format associated with the raster graphics plan. It is envisioned that at least a crude vector graphics specification of the raster graphics specified plan can be extracted therefrom with a reasonably well scaled/oriented virtual ruler, such extraction can include at least extraction of position information about orientation/positioning markers. One of the advantages of this approach includes enabling the scanning in of paper printed plans when a vector graphics specification is not readily available.

In accordance with yet another embodiment of the proposed solution, XML converted plans, including annotations if any, can be conveyed electronically externally to the electronic collaboration table 100, for example with a remote plan storage database and/or version control server, as well conveyed between electronic collaboration tables 100 and/or electronic collaboration clients such as a touch screen phone, a touch screen personal information manager, a tablet, etc. implementing the features described herein.

The proposed solution is not limited to any engineering, architectural, civil, etc. discipline; the invention is equally applicable to other fields, for example Global Information Systems (GIS). In addition to the above mentioned information, GIS applications also include information having plan coordinates. Even such information can be represented in XML together with plan coordinates and displayed, of example as icons, pinned to the plan at the coordinates. Rotating and zooming in/out interaction can be configured to selectively scale and rotate the icons independently of the plan. Icon scaling and rotation can be selectively suppressed.

While the invention has been shown and described with referenced to preferred embodiments thereof, it will be recognized by those skilled in the art that various changes in form and detail may be made therein without departing from the spirit and scope of the invention as defined by the appended claims.

What is claimed is:

1. An electronic collaboration table for interaction with design drafting plans, the apparatus comprising:
a high definition television (HDTV) flat panel screen display having a diagonal image measurement of between 45 to 65 inches, said HDTV flat panel screen display having a frame height greater than 30 inches;
a wheeled base frame for supporting the flat screen display at a fixed acute angle in a landscape orientation at a height suitable for working at said display while seated or standing, said support frame and said angle allowing said display mounted on said support frame to be wheeled through a 30 inches doorframe; and
a multi-touch recognition system mounted to said table for recognizing operator finger touches on said flat screen display.

2. A collaboration table as claimed in claim 1, said multi-touch recognition system further comprising a touch detection system defining a touch screen interface, the touch detection system including one of a capacitive layer, an Infra-Red (IR) beam interrupt grid and an IR field plate.

3. A collaboration table as claimed in claim 1, wherein said touch screen interface includes a 55 in LCD flat screen display having full high definition resolution and said acute angle being fixed at about 40°.

4. A collaboration table as claimed in claim 1, said flat screen display having a display frame, said multi-touch recognition system further comprising an IR beam interrupt beam grid frame, said display frame being configured to support said IR beam interrupt grid frame, said flat screen display and said IR beam interrupt grid frame being encased in a bezel protecting said multi-touch recognition system and flat screen display from side impact.

5. A collaboration table as claimed in claim 1, said bezel contributing at least 1.5 inch to at least one side dimension of said collaboration table.

6. A collaboration table as claimed in claim 1 wherein said support frame and flat screen display define a desk-like structure.

7. A collaboration table as claimed in claim 1, said desk-like structure further comprising a keyboard tray in sliding engagement therewith for supporting a physical keyboard.

8. A collaboration table as claimed in claim 1, further comprising a protective layer over said flat screen display protecting at least said flat screen display from direct impact.

9. A collaboration table as claimed in claim 1, further comprising a secondary display selected from a flat screen display and a projector display.

10. A collaboration table as claimed in claim 1, further comprising one of a bracket and a shelf for supporting said secondary display.

11. A collaboration table as claimed in claim 1, wherein said projector display is supported on said shelf in slidable engagement with said collaboration table.

12. A collaboration table as claimed in claim 1, said multi-touch recognition system further comprising a gesture freeze physical button.
